(19) United States
(12) Patent Application Publication
(10) Pub. No.: US 2022/0400610 A1
(43) Pub. Date: Dec. 22, 2022

(54) BLOWER ATTACHMENT FOR VEHICLES

(71) Applicant: Harper Industries, Inc., Harper, KS (US)

(72) Inventor: Jim L. Seipel, Anthony, KS (US)

(73) Assignee: Harper Industries, Inc., Harper, KS (US)

(21) Appl. No.: 17/807,629

(22) Filed: Jun. 17, 2022

Related U.S. Application Data
(60) Provisional application No. 63/212,379, filed on Jun. 18, 2021.

(51) Int. Cl. A01D 34/71; A01D 34/64

(52) U.S. Cl. CPC A01D 34/71; A01D 34/64; A01D 2101/00

(57) ABSTRACT

A debris dispersal system for use with a vehicle comprises a blower assembly, a nozzle assembly, and first and second discharge conduits. The blower assembly is supported on a frame having at least one rolling support and includes an engine drivingly connected to a blower having a radial housing. The nozzle assembly includes at least one elongate nozzle, wherein each nozzle has at least one discharge opening configured to direct air downwards from the nozzle. The first and second discharge conduits each have a proximal end connected to the blower and a distal end connected to the nozzle assembly in spaced relation.

### CROSS-REFERENCE TO RELATED APPLICATIONS

This application claims the benefit of provisional patent application Ser. No. 63/212,379, filed Jun. 18, 2021, the contents of which are incorporated herein by reference.

### BACKGROUND OF THE INVENTION

### Field of the Invention

This invention relates to blower attachments for vehicles and in particular blower attachments for mowers to disperse clumps of grass or turf clippings left behind a mower.

### Description of the Related Art

Golfers prefer playing on well-manicured turf and golf course superintendents strive to provide tee boxes, fairways and greens that are free from debris to provide an enjoyable experience for the golfers. Fairways and greens are typically mowed early in the morning in order to minimize impeding the play of the golfers. Dew or condensation accumulating on the grass overnight increases the propensity for grass clippings to accumulate on the reel housings of reel type mowers or on portions of the mower undercarriage and fall off in the form of clumps behind the mower during the mowing process. Such clumps are unsightly and can interfere with play.

An existing approach to addressing the clumps created by fairway mowers is to have a member of the grounds crew pull a blower behind a utility vehicle to disperse the clumps. Such blowers are adapted for blowing debris off of other types of surfaces including roads, paths, parking lots, lawns or recreational areas. One such blower assembly is sold as the Toro Pro Force debris blower and comprises a blower and engine mounted on a trailer which can be connected to and towed behind a utility vehicle or mower. The Pro Force debris blower includes a curved, cylindrical nozzle which is rotatable to direct a stream of air in a desired direction relative to the trailer. US Patent Application Publication No. US 2012/0255585 of Kowalczyk also discloses a blower assembly which can be towed behind a vehicle or mounted on a mower and includes an air knife type nozzle for distributing a curtain of air laterally relative to the direction of travel of the vehicle. The blower disclosed in the Kowalczyck publication is adapted for use on a wide variety of surfaces which are typically relatively flat

There remains a need for a debris blower particularly adapted for use on uneven surfaces such as golf course fairways or greens and which will not negatively impact the performance of the mower with which it is used.

### SUMMARY OF THE INVENTION

The present invention comprises a clipping or debris dispersal assembly adapted to be mounted on the rear of a riding mower and preferably a reel type riding mower to disperse clumps of grass generated during mowing of relatively wet turf such as golf course fairways. A first embodiment of the debris dispersal assembly comprises a blower assembly supported on a platform which is pivotally connected on one side to the mower frame by a mower mounting bracket and supported on the other side by a rolling support which engages and rolls along the ground. An elongated nozzle is suspended below the platform and extends laterally relative to the platform. The blower assembly includes a blower, an engine and a transmission drivingly connecting the engine to the blower. The pivotal connection between the platform and the mower mounting bracket allows the platform to pivot about a horizontal axis. The dispersal assembly preferably includes a height adjustment means for adjusting the height of the platform relative to the mower mounting bracket.

The elongated nozzle has at least one discharge opening formed therein and oriented for directing air downward from the nozzle. The nozzle is connected to a discharge opening of the blower by a discharge conduit. The nozzle is preferably formed form a center section, a left section and a right section. The left section and the right section are pivotally connected to the center section such that the left section and the right section may be pivoted vertically relative to the center section when not in use for dispersing debris from a section of turf. The nozzle may be formed from upper and lower channels connected together to form an interior space therebetween and the at least one discharge opening in the nozzle comprises an elongated air discharge slot formed between the upper and lower channels in communication with the interior space. The channels may be semi-hexagonal in cross-section.

The discharge conduit of the debris dispersal assembly includes a plenum connected to the discharge opening of the blower and left and right conduit branches connected between the plenum and the center section of the nozzle. The left branch includes a left horizontal section connected to and projecting from a left side of the plenum, a left elbow connected to the left horizontal section and a left vertical segment connected between the nozzle and the left elbow. The right branch includes a right horizontal section connected to and projecting from a right side of the plenum, a right elbow connected to the right horizontal section and a right vertical segment connected between the nozzle and the right elbow. The left and right elbows are rotatably connected to the left and right horizontal segments of the discharge conduit such that the nozzle is rotatable relative to the left and right horizontal segments. Left and right clamping rings surrounding a portion of the left and right elbows extending over the left and right horizontal segments respectively may be tightened to selectively clamp the left and right elbows to the left and right horizontal segments respectively to restrain the nozzle from pivoting relative to the horizontal segments of the discharge conduit. The nozzle may be suspended from the left and right horizontal segments by left and right hangers extending between the left and right clamping rings and the nozzle.

The transmission of the debris dispersal assembly is connected between an engine output shaft and a blower shaft. The transmission preferably includes a centrifugal clutch or a continuous variable transmission connected to the engine output shaft such that the transmission does not drivingly engage the blower shaft until the engine output shaft reaches a set revolutions per minute to allow the engine to start under a reduced load and to idle without turning the blower.

In another embodiment, a debris dispersal assembly for use with a vehicle comprises a blower assembly supported on a platform, a mower mounting bracket, first and second discharge conduits, and first and second rolling supports. The blower assembly includes a blower and an engine drivingly connected to the blower. The mower mounting bracket is securable to a frame of the vehicle and pivotally connected to the platform. The first and second discharge conduits each have a proximal end connected to a discharge opening of the blower and a distal end connected to an elongate nozzle, each nozzle having at least one discharge opening configured to direct air downward from the nozzle. The first and second rolling supports are connected to the platform and are located on opposite sides of the platform.

The blower comprises a radial housing having first and second internal adjacent radial channels of substantially equal cross-sectional area. There is a first set of impeller blades disposed within the first radial channel, and a second set of impeller blades disposed within the second radial channel. The first set of impeller blades and second set of impeller blades are mounted upon a common shaft which is driven by the engine.

In still another embodiment, a debris dispersal system for use with a vehicle comprises a blower assembly supported on a frame, a nozzle assembly, and first and second discharge conduits. The blower assembly includes an engine drivingly connected to a blower, the blower having a radial housing with first and second internal radial channels of substantially equal cross-sectional area, a first set of impeller blades disposed within the first radial channel, and a second set of impeller blades disposed within the second radial channel, wherein the first set of impeller blades and second set of impeller blades are mounted to rotate about a common axis. The nozzle assembly includes at least one nozzle, each nozzle having at least one discharge opening configured to direct air downward from the nozzle. The first and second discharge conduits each have a proximal end connected to the blower and a distal end connected to the nozzle assembly in spaced relation.

The objects and advantages of this improvement will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is a front, perspective view of a first embodiment of a debris dispersal assembly connected to a reel type riding mower with left and right sections of a nozzle retracted relative to a center section.

FIG. 2 is a top plan view of the debris dispersal assembly connected to the riding mower as shown in FIG. 1 with the left and right sections of the nozzle extended in axial alignment with the center section.

FIG. 3 is an exploded, perspective view of the debris dispersal assembly as shown in FIG. 1.

FIG. 4 is a rear perspective view of the debris dispersal assembly of FIG. 1.

FIG. 5 is a right, side elevational view of the debris dispersal assembly of FIG. 1.

FIG. 6 is a rear, elevational view of the debris dispersal assembly of FIG. 1.

FIG. 7 is an enlarged and fragmentary cross-sectional view taken along line 7-7 of FIG. 6.

FIG. 8 is an enlarged and fragmentary, rear perspective view of the debris dispersal assembly of FIG. 1, showing a hanger supporting a nozzle from an air discharge conduit.

FIG. 9 is an enlarged and fragmentary, rear perspective view of the debris dispersal assembly of FIG. 1 positioned adjacent a rear end of the riding mower to which it is to be attached.

FIG. 10 is a front, perspective view of a second embodiment of a debris dispersal assembly connected to a riding mower with left and right nozzles retracted into an upright or storage configuration.

FIG. 11 is a top view of the debris dispersal assembly of FIG. 10 with the left and right nozzles extended in a horizontal or usage configuration.

FIG. 12 is an exploded view of the debris dispersal assembly of FIG. 10.

FIG. 13 is a rear perspective view of the debris dispersal assembly of FIG. 10, showing the rotation of the left and right nozzles within a horizontal plane when in the operational configuration.

FIG. 14 is a right, side elevational view of the debris dispersal assembly of FIG. 10.

FIG. 15 is a rear, elevational view of the debris dispersal assembly of FIG. 10.

FIG. 16 is an enlarged and fragmentary section view of the debris dispersal assembly of FIG. 10, taken along section line 16-16 of FIG. 15.

FIG. 17 is a bottom view of the debris dispersal assembly of FIG. 10, showing the rotation of the left and right nozzles within a horizontal plane when in the operational configuration.

FIG. 18 is an enlarged and fragmentary section view of the debris dispersal assembly of FIG. 10, taken along section line 18-18 of FIG. 15.

FIG. 19 is a partial exploded view of a discharge conduit of a debris dispersal assembly.

FIG. 20 is a partial, front perspective view of the debris dispersal assembly of FIG. 10, wherein portions of the blower housing are removed.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

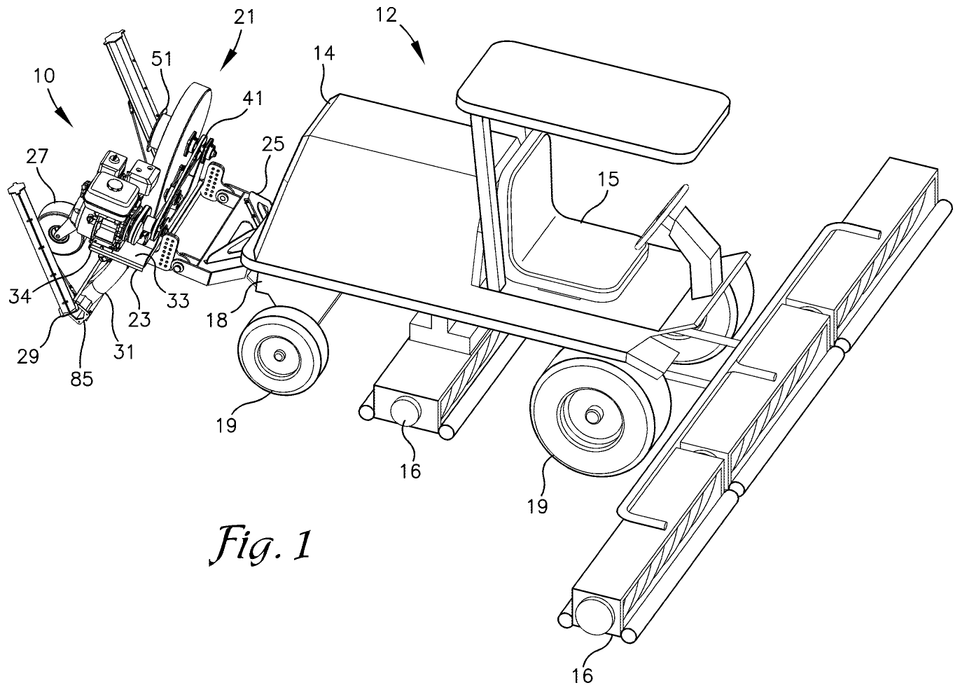

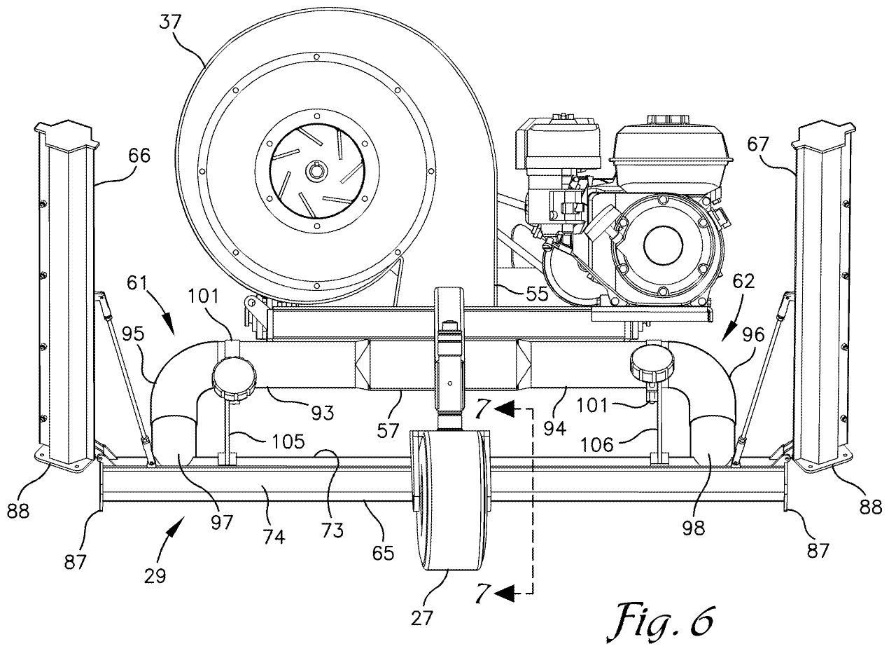

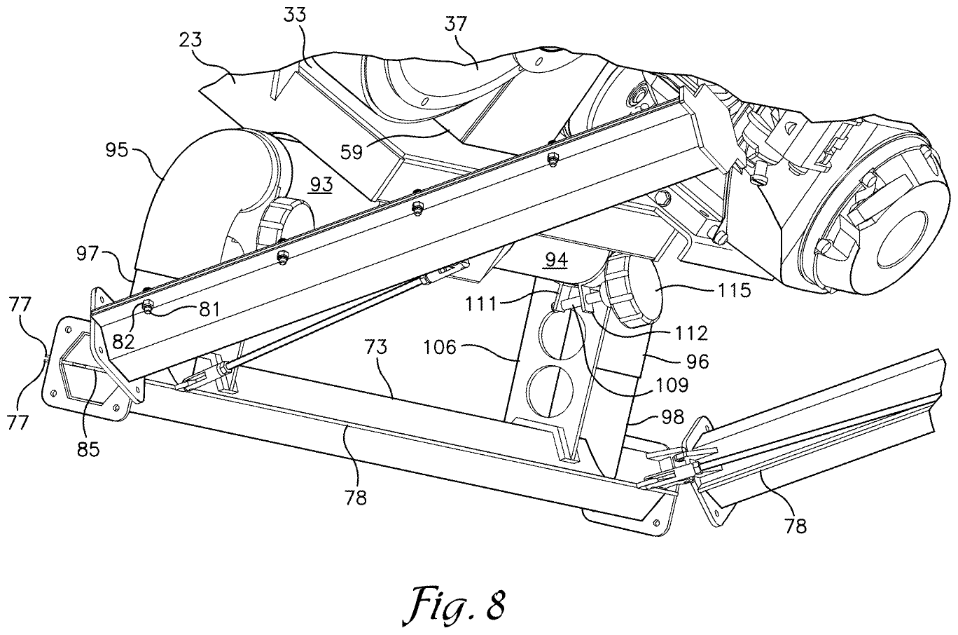

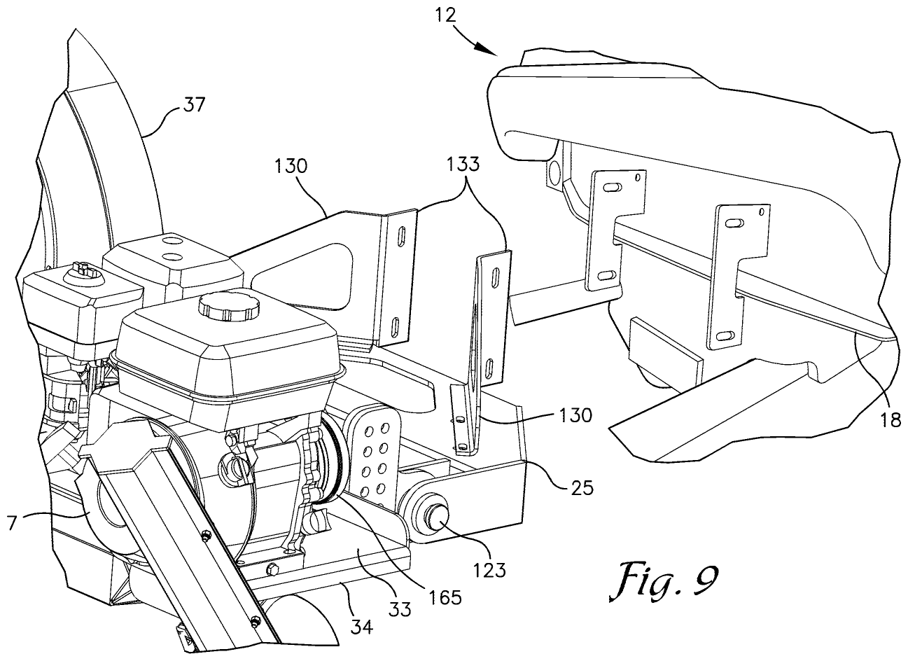

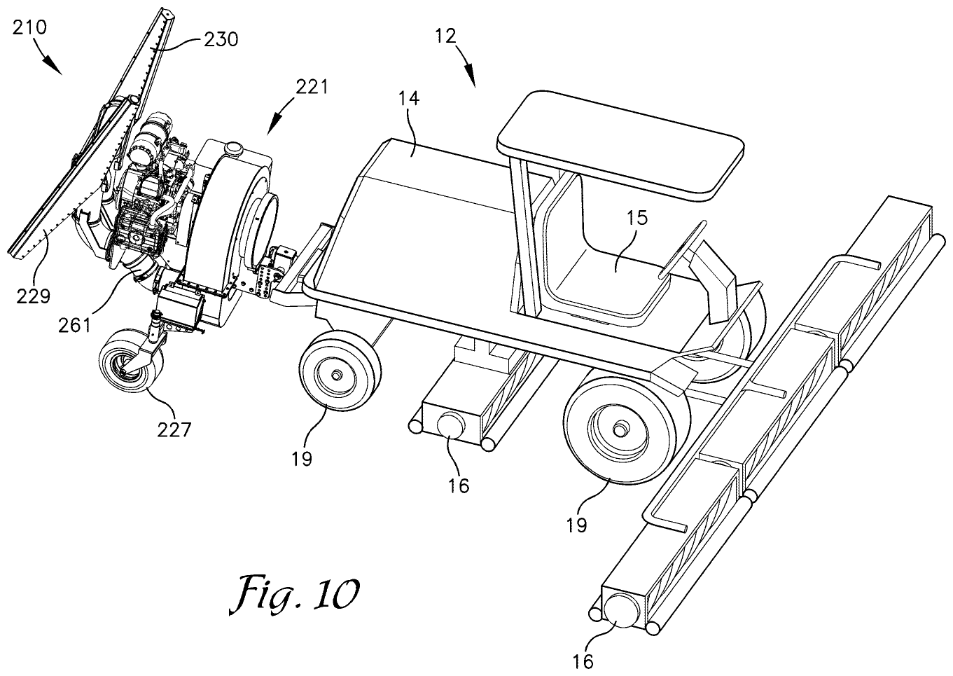

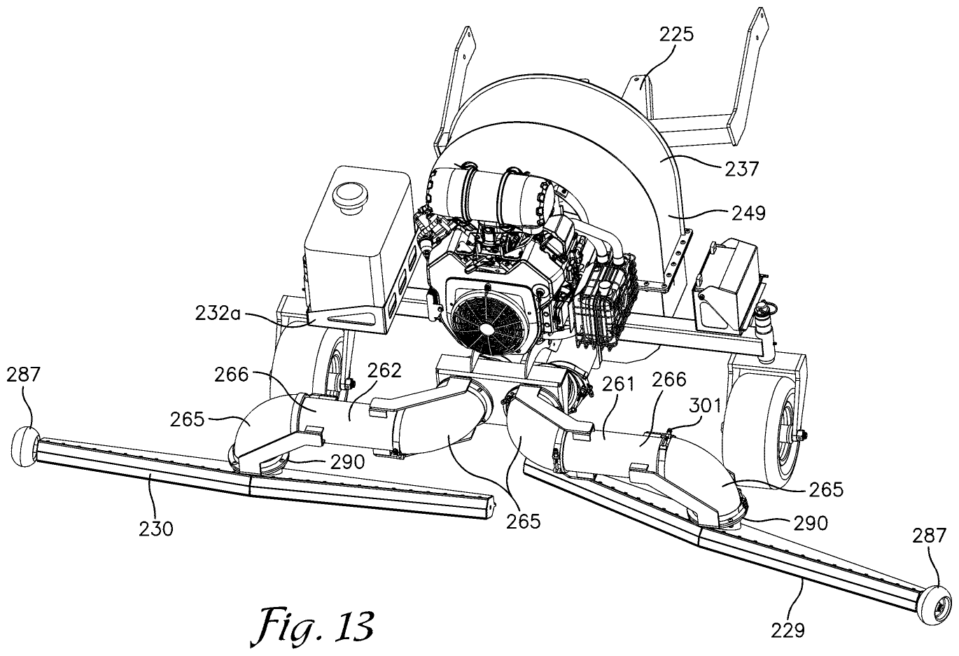

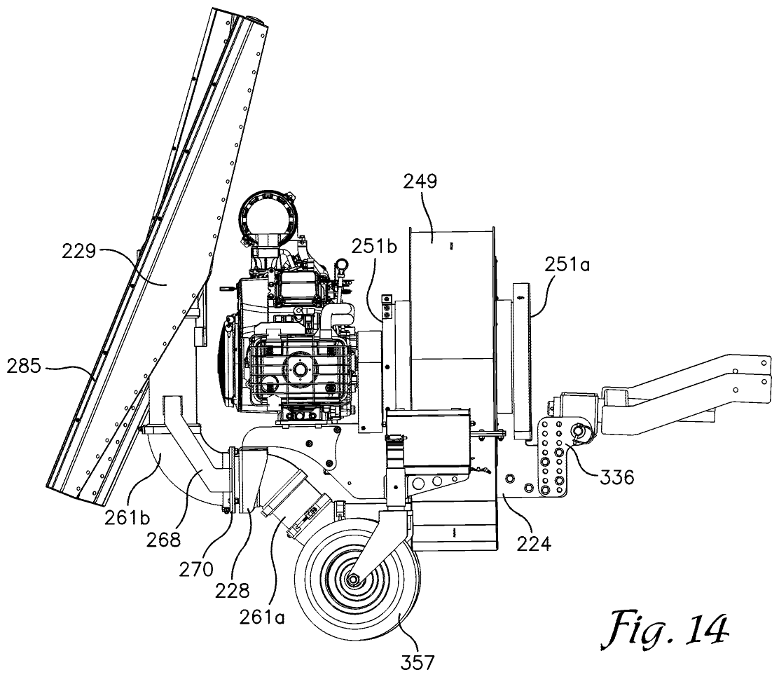

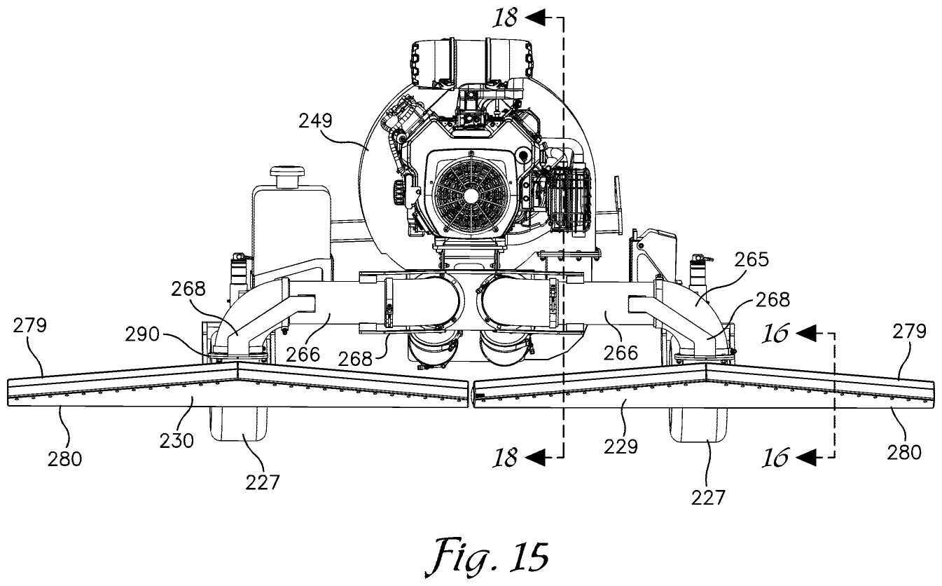

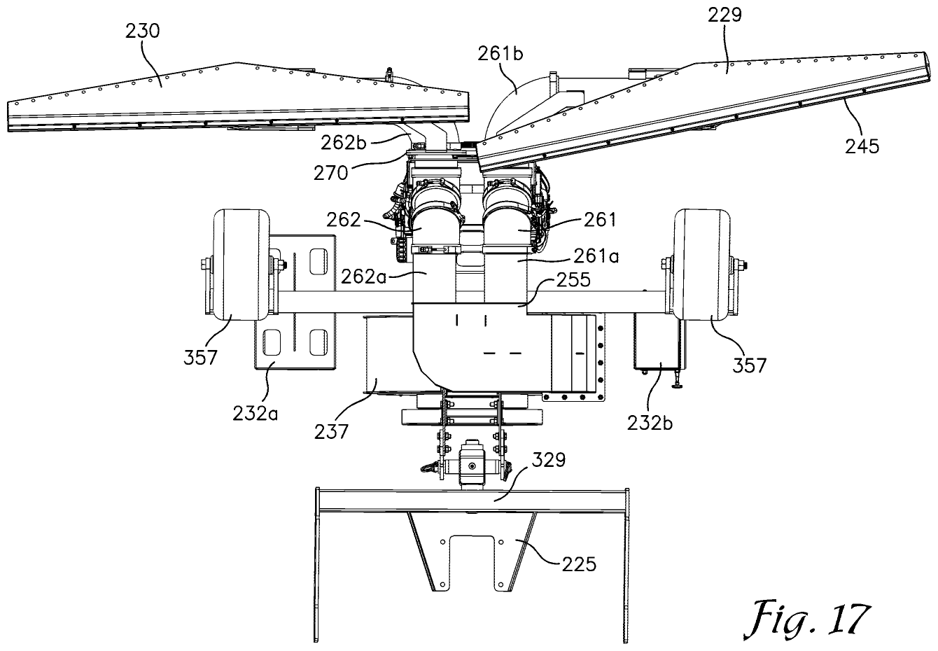

FIGS. 1-9 show a debris dispersal system 10 according to a first embodiment of the invention. FIGS. 10-19 illustrate a second embodiment 210 of a debris dispersal system. Referring to FIGS. 1-9 and the first embodiment in more detail, the reference number 10 refers to a debris dispersal system or assembly mounted on the back of a reel type fairway mower 12 and operable to discharge a stream of air across the path of the mower 12 to disperse clumps of grass falling off of the mower onto the turf. The mower 12 includes an engine 14, operator seat 15 and a plurality of cutting units 16 mounted on a frame 18 which is supported on wheels 19. The cutting units 16 for mowers used on a golf course are typically reel type cutting units due to the preferred scissor type cutting action of the reels versus the cut provided by rotary blade type mowers. A typical fairway mower will include three reels 16 mounted across the front of the mower 12 and two reels 16 beneath the engine 14 which is typically positioned behind the operator seat 15. The two reels 16 under the engine 14 are mounted in overlapping relationship with the gaps between the three forward positioned reels 16. As used herein the directional references made to the debris dispersal system 10 correspond to the directional references of a mower 12 to which it is attached and with respect to an operator seated on the operator seat 15 of the mower 12 and facing forward in the direction the mower 12 normally moves for mowing.

In the illustrated and preferred embodiments, the debris dispersal system 10, 210 is used with a typical fairway mower 12, although it is foreseen that in other embodiments, the debris dispersal system may be used with any number of suitable maintenance vehicles known to those in the art. In some embodiments not shown, the debris dispersal system may be self-propelled or be configured for manual operation as well.

The debris dispersal system 10 shown includes a blower assembly 21 supported on a platform or frame 23 pivotally secured on one side to the mower frame 18 by a hinged or pivoting bracket assembly 25 and supported on the opposite side by a rolling support 27. In the embodiment shown, a forward or leading end of the platform 23 is pivotally connected to the mower frame 18 at a rear end thereof. An elongated nozzle 29 is suspended below and extends laterally relative to the platform 23. A conduit assembly 31 is connected between the blower assembly 21 and the nozzle 29 for directing pressurized air from the blower assembly 21 to the nozzle 29 and out a discharge opening in the nozzle 29.

In the embodiment shown in FIGS. 1-9, the platform 23 is rectangular and formed from a flat panel 33 supported on a rectangular frame 34. The blower assembly 21 includes a source of pressurized air such as a centrifugal blower 37, an engine 39 and a transmission 41 drivingly coupling a blower shaft 43 to an engine output shaft 45.

The blower 37 includes an impeller 47 mounted in a housing or casing 49 and connected to the blower shaft 43. An inlet 51 is mounted on the housing 49 and forms an air inlet passageway 53 extending through the housing 49 in axial alignment with the blower shaft 43 and impeller 47. In the embodiment shown, the inlet 51 is mounted on a rear face of the housing 49 and opens rearward. A discharge 55 of the blower housing 49 is flow connected to a plenum, manifold or air distribution box 57 of the conduit assembly 31 through an opening 59 formed through the flat panel 33 of the platform 23. The conduit assembly 31 shown includes two branches or cylindrical ducts including left branch 61 and right branch 62 flow connected between the plenum 57 and the nozzle 29 and extending laterally from the left and right sides of the plenum 57 respectively.

The nozzle 29 of the embodiment shown may also be referred to as an air knife. The nozzle or air knife 29 is formed as an elongate, segmented tube having a center section 65 and left and right sections or wings 66 and 67 which are pivotally connected to the center section 65 by left and right hinge assemblies 68 and 69 to allow the left and right wings 66 and 67 to be pivoted vertically when not in use to reduce the overall width of the nozzle 29 during transport and when not in use. Telescoping connector rods 71 and 72 extend between center section 65 and the left and right wings 66 and 67 respectively and function to limit the pivoting of the left and right wings 66 and 67 to a vertical orientation just past vertical to help hold the wings 66 and 67 in an upright folded alignment when not in use.

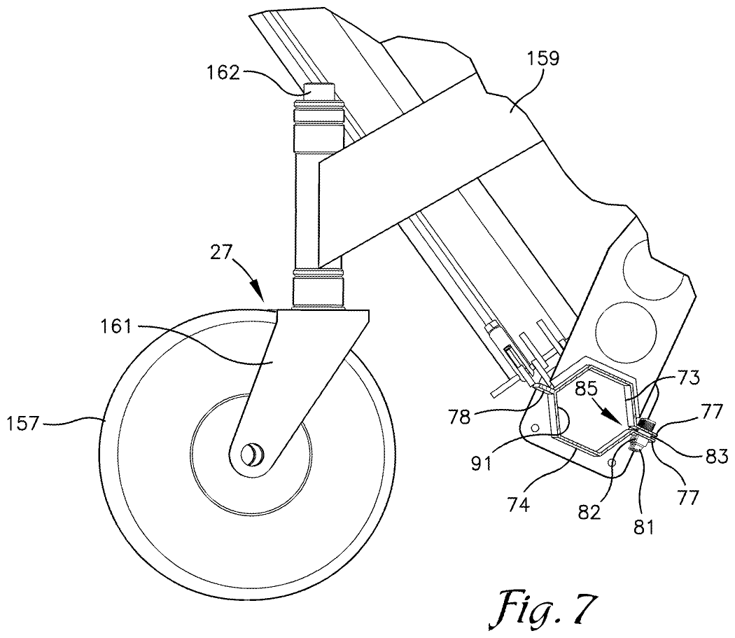

As shown in FIG. 7, each section of the nozzle or air knife 29 is formed from upper and lower or first and second lengths of semi-hexagonal channels 73 and 74 secured together to form a hexagonal tube. Front and rear or first and second mounting flanges 77 and 78 project outward from the sides of each of the semi-hexagonal channels 73 and 74. The rear mounting flanges 78 of the upper and lower channels 73 and 74 are secured together in abutting relationship using fasteners, welding or the like. Alternatively, the channels 73 and 74 could be formed from a single piece of sheet metal or sheet material and folded over along a centerline between the portion of the sheet metal corresponding to the rear mounting flanges 78. The front mounting flanges 77 of the upper and lower channels 73 and 74 are secured together in spaced apart relationship by fastener assemblies such as screws 81 and nuts 82. A spacer 83 is shown positioned around each screw 81 and between the front mounting flanges 77 of channels 73 and 74 to maintain a desired spacing between the front flanges 77 to form an air discharge outlet or slot 85 extending the length of each section 65, 66 and 67 of the nozzle or air knife 29.

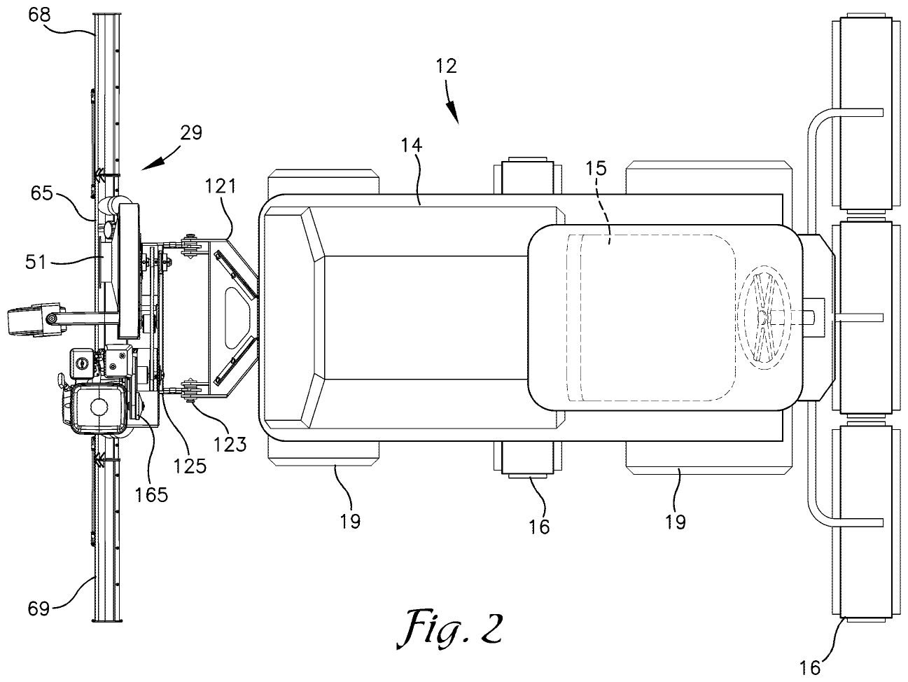

Abutment flanges 87 extend radially outward from each end of the center section 65 of nozzle 29 and mating abutment flanges 88 and 89 extend radially outward from the inner end of the left and right wings 66 and 67 of the nozzle 29. Distal ends of the left and right wings 66 and 67 are closed and the inner ends are open as are each end of the center section 65. Abutment flanges 88 and 89 on wings 66 and 67 abut against the abutment flanges 87 on the ends of center section 65 when the wings 66 and 67 are pivoted or extended into axial alignment with the center section 65. Interior spaces 91 formed by the upper and lower channels 73 and 74 of each nozzle section 65, 66 and 67 extend in alignment and in communication when the wings 66 and 67 are positioned or extended into axial alignment with the center section 65. As shown in FIG. 2, the nozzle sections 65, 66 and 67 are sized to be approximately the same width or slightly wider than the width or cutting width of the mower 12 to create a curtain of air that is approximately the same width as the mower 12 to act on clumps of grass which might fall off of any portion of the mower 12.

The left and right branches 61 and 62 of the conduit assembly 31 comprise left and right horizontal segments 93 and 94, left and right elbows 95 and 96 and left and right vertical segments 97 and 98. The left and right horizontal segments 93 and 94 are formed from rigid conduit or tubing and project laterally outward from the left and right sides respectively of the air distribution box 57. Upper, inner ends of the left and right elbows 95 and 96 are rotatably secured to distal ends of the left and right horizontal segments 93 and 94. In the embodiment shown, the inner end of each elbow 95 and 96 fits over a distal end of the respective left and right horizontal segment 93 and 94 and is securable thereto by clamping means such as ring clamps 101. The left and right vertical segments 97 and 98 are connected at lower ends to the upper semi-hexagonal channel 73 forming the nozzle 29 proximate opposite ends thereof. The vertical segments 97 and 98 surround openings through the channel 73 to communicate with the interior spaces 91 enclosed by the upper and lower channels 73 and 74. An upper end of each vertical segment 97 and 98 is connected to a lower end of each elbow 95 and 96. In the embodiment shown, the upper end of each vertical segment 97 and 98 is pressed into the lower end of each elbow 95 and 96.

Left and right nozzle hangers 105 and 106 are connected between the left and right horizontal segments 93 and 94 and the left and right sides of the upper channel 73 of the nozzle 29. Lower ends of each hanger 105 and 106 are fixedly secured to the upper channel 73 and upper ends of the hangers 105 and 106 are secured to a respective ring clamp 101 secured around the left and right horizontal segments 93 and 94 of the conduit assembly 31 with the upper, inner end of a respective elbow 95 and 96 extending between the respective horizontal segment 93 and 94 and the ring clamp 101. A screw 109 threaded extending through threaded holes in aligned flanges 111 and 112 on the fixed and free ends of the ring clamp is used to change the diameter of the ring clamp 101. The ring clamps 101 may be loosened, using knob 115 on the end of each screw 109, to allow manual rotation of the elbows 95 and 96, vertical segments 97 and 98 and attached nozzle 29 relative to the left and right horizontal segments 93 and 94 to adjust an angle at which the discharge slot 85 of nozzle 29 is oriented relative to the ground. Tightening of the ring clamps 101 then fixes the angular position of the nozzle 29 relative to the horizontal segments 93 and 94 and relative to the ground over which the mower 12 moves.

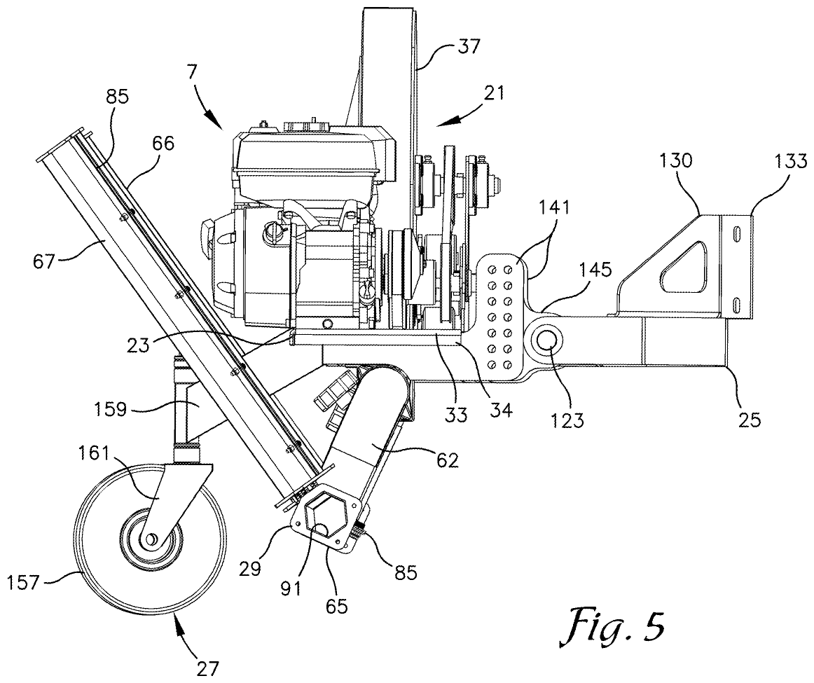

Pressurized air discharged from the blower 37 through discharge 55 is directed through the air distribution box 57, the left and right branches 61 and 62 of the conduit assembly 31 into the interior space 91 of the nozzle 29 and out the air discharge slot 85 formed in each nozzle section 65, 66 and 67. In the embodiment shown and with reference to FIG. 5, the nozzle 29 is oriented with the air discharge slot 85 directing a stream of air downward at an acute angle of approximately forty-five degrees from a plane through the flat panel 33 on frame 34 to generally direct the stream of air toward the ground at an angle of forty-five degrees from horizontal. The slot opens back toward a front end of the platform 23 and toward the rear of the mower 12 to which it is attached to direct the stream of air discharged from the slot 85 in the direction of travel of the mower 12 when moving forward. It is foreseen that the angle of a plane through the air discharge slot 85 (with the wings 66 and 67 of the nozzle 29 extended) relative to a generally horizontal plane through the flat panel 33 would preferably range from about 30 to 90 degrees such that an angle of incidence of the discharged air relative to the ground may range between 30 to 90 degrees. The discharge slot 85 may be oriented to direct air discharged therefrom forward or rearward relative to the direction of travel of the mower 12.

The hinged bracket assembly 25 cooperates with the rolling support 27 connected to platform 23 to maintain the nozzle 29 at a relatively constant spacing relative to the ground over which the debris dispersal system 10 is advanced. The hinged bracket assembly 25 includes a mower mounting bracket 121 pivotally connected by a hinge assembly 123 to left and right height adjustment assemblies 125 connected to the rectangular frame 34 supporting the blower assembly 21. The mower mounting bracket 121 is preferably constructed to permit ready attachment to a variety of mowers 12 from different manufacturers or which is relatively easily modified to permit attachment to a variety of mower models. In the embodiment shown, the mower mounting bracket 121 includes a base or baseplate 129 having a pair of bolting flanges 133 connected to the base 129 by gussets 130. The bolting flanges 133 extend upward and forward from an upper surface of the base 129. The bolting flanges 133 have bolt holes extending therethrough and the flanges are sized, shaped and spaced apart a selected distance to facilitate bolting of the mounting bracket 121 to the frame 18 of a selected mower 12.

Each of the height adjustment assemblies 125 comprises front and rear multi-hole plates 141 and 142 positioned in side-to-side, overlapping alignment. The front plate 141 of each assembly 125 includes a forwardly projecting tab 145 which forms part of the hinge 123. The rear plate 142 of each height adjustment assembly 125 as shown is integrally formed with and extends forward from the rectangular frame 34. It is foreseen that each rear plate 142 could be formed separate from and secured to the frame 34 by bolting or welding or other suitable means. Each plate 141 and 142 includes a plurality of bolt holes 147 formed therein in vertical alignment in two columns. The vertical position of the front plate 141 relative to the adjacent rear plate 142 can be adjusted before bolting the plates 141 and 142 together through aligned sets of bolt holes 147 to adjust the height of the platform 23 relative to the mower mounting bracket 121.

The hinge 123 is formed from left and right pivot brackets 151 and 152 formed on or secured to and projecting rearward from a rear end of the mounting bracket base 129. The tab 145 of each of the front multi-hole plates 141 is pivotally secured to a respective one of the pivot brackets 151 and 152 by a pivot pin or bearing 154 extending through aligned holes in each of the pivot brackets 151 and 152 and the tab 145.

The rolling support 27 comprises a wheel 157 mounted on the distal end of a wheel support leg 159 which is connected at an upper end to the rear of the rectangular frame 34 of the platform 23. The wheel 157 is rotatably mounted on a yoke 161 which is pivotally connected to the distal end of the wheel support leg 159 on a pivot shaft 162. The wheel 157 and yoke 161 may also be referred to as a caster wheel. The wheel support leg 159 slopes downward and rearward from the platform 23 to position the wheel 157 in relatively close spaced relation behind the nozzle 29. As the wheel 157 rolls over and follows the contours of the ground, the nozzle 29 will move up or down relative to the mower 12 due to the pivotal connection between the mower and the platform from which the nozzle 29 is suspended.

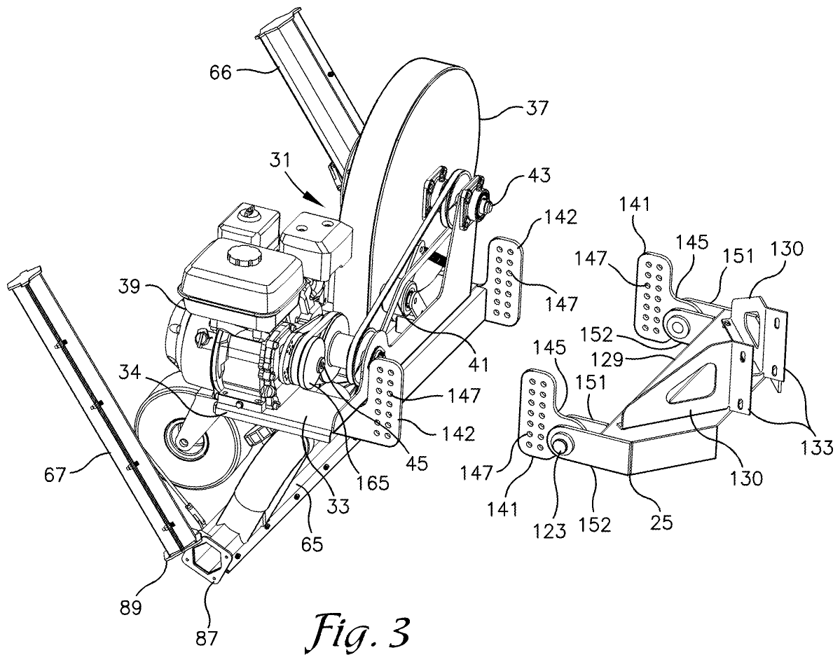

Referring to FIG. 3, the transmission 41 may incorporate a centrifugal clutch 165 or a continuous variable transmission connected to the engine output shaft 45 which will not engage the blower shaft 43 until the output shaft reaches a set revolutions per minute in order to reduce the load on the engine when starting and to allow the engine to idle without driving the blower impeller 47. An engine speed controller (not shown) for the blower assembly engine 39 can be mounted near the operator seat 8 to allow the operator of the mower 12 to control the engine speed and therefore the blower output independent of the mower speed and operation.

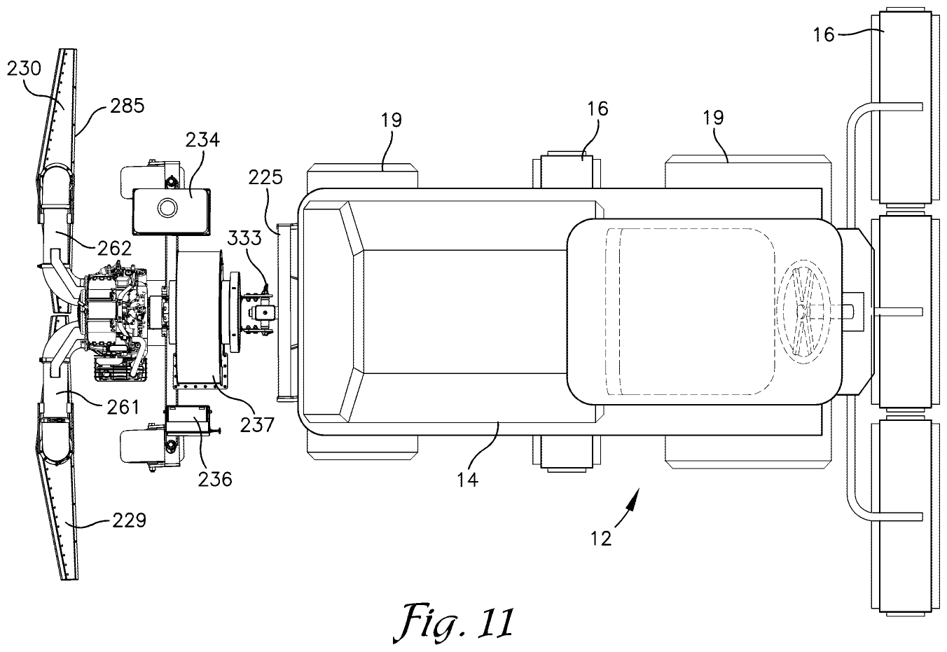

Turning now to FIGS. 10-19, debris dispersal system 210 is similar in function to dispersal system 10, with certain structural differences, as will be discussed further. As seen in FIGS. 10 and 11, debris dispersal system 210 is configured to mount to a mower 12, and is towed behind the mower 12 (or other suitable vehicle) to discharge a stream of pressurized air along the width of the mower 12 to disperse debris (typically clumps of grass clippings) from the turf. As in FIGS. 1-9, the directional references made to the debris dispersal system 210 correspond to the directional references of the mower 12 to which it is attached and with respect to an operator seated on an operator seat 15 of the mower 12, facing forward in the typical direction of travel. For uniformity and brevity, the reference numbers 200-399 of the dispersal system 210 generally correspond to the reference numbers 1-199 of the dispersal system 10 (e.g. blower assembly 21 and blower assembly 221, engine 39 and engine 239, multi-hole plate 141 and multi-hole plate 341, etc.), though with any noted, shown, or inherent deviations.

The debris dispersal system 210 includes a blower assembly 221 supported on a platform or frame 223 pivotally secured on one side to a portion of the mower frame by a mower mounting bracket assembly 225 and supported by rolling supports 227. A pair of elongated nozzles 229 and 230 are connected to the blower assembly 221 via a discharge conduit assembly 231 and are configured to direct pressurized air from the blower assembly 221 towards the ground through a discharge slot 285.

In the embodiment shown in FIGS. 10-19, the mower mounting bracket assembly 225 includes a pivoting hinge assembly or dual-axis pivot assembly 323 connected to a rear end of a base 329 thereof. The dual-axis pivot assembly 323 includes a cylindrical, pivot shaft 330 projecting outward or rearward from the base 329, a hinge pin assembly 331 rotatably mounted on the pivot shaft 330 with hinge pins 332 and 333 projecting laterally outward from a pivot shaft bearing 335, and hinge plates or leaves 336 and 337 pivotally mounted on the hinge pins 332 and 333 respectively. The hinge pins 332 and 333 may also be referred to as trunnions 332 and 333. In the embodiment shown, when the mower mounting bracket 225 is connected to a mower 12, a longitudinal axis of the pivot shaft 330 extends in parallel alignment with a longitudinal axis through the mower 12.

The hinge plates 336 and 337 including two sets of vertically aligned bolt holes formed therein which are sized and spaced apart a distance to allow the hinge plates 336 and 337 of dual-axis pivot assembly 323 to be positioned laterally adjacent to and longitudinally in alignment with platform mounting brackets 341 and 342 projecting forward from the platform 223. A pair of vertically aligned bolt holes formed in the platform mounting brackets 341 and 342 may be selectively aligned with one of a plurality of pairs of bolt holes in the hinge plates 336 and 337 and then secured in the selected alignment with bolts or pins inserted through the aligned sets of holes to adjust the vertical position of the platform relative to the mower 12 or mower frame 18. The dual-axis pivot assembly 323 allows the platform 223 and the blower assembly 221 supported thereon to pivot side-to-side about the longitudinal axis extending through pivot shaft 330 and up and down about hinge pins 332 and 333.

The frame 223 also includes blower assembly mounting brackets 224, engine mounting brackets 226, and discharge conduit bracket 228. The platform or frame 223 may also include additional mounting brackets 232a, 232b for holding a fuel tank 234 and battery 236, respectively.

The frame 223 is supported by a pair of rolling supports 227 disposed at opposite sides of the frame and pivotally connected to the frame 223. The rolling supports 227 each include a wheel 357 mounted on the distal end of a wheel support leg 359 which is connected at left or right side of the frame 223 of the. The wheel 357 is rotatably mounted on a yoke 361 which is pivotally connected to the distal end of the wheel support leg 359 on a pivot shaft 362. The wheels 357 and yokes 361 may also be referred to as caster wheels. As the wheel 357 rolls over and follows the contours of the ground, the nozzles 229 and 230 will move up or down relative to the mower 12 due to the pivotal connection between the mower and the platform from which the nozzles 229 and 230 are suspended.

The blower assembly 221 includes a source of pressurized air such as a centrifugal blower 237 and an engine 239 drivingly connected to a blower shaft 243. Unlike the previous embodiment, the embodiment shown in FIGS. 10-19 does not include a transmission and separate engine output shaft, and instead the engine 239 is directly connected to the blower 237. This may reduce the size and complexity of the design, and consequently reduce cost and/or maintenance requirements compared to other embodiments.

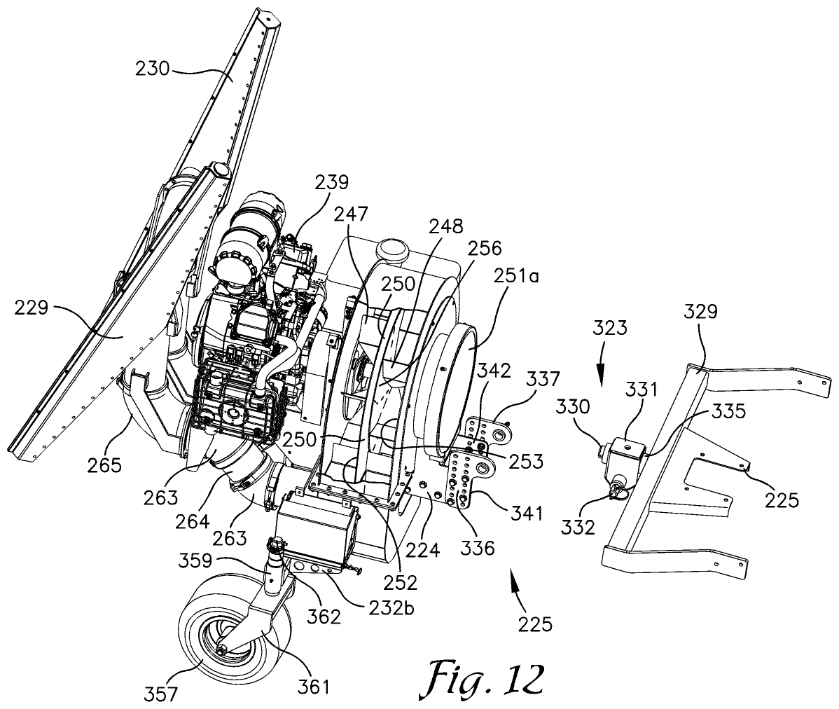

The blower 237 has a radial housing or shroud 249 having a pair of inlets 251a and 251b disposed on opposite sides of the housing 249. As best seen in FIG. 12, compared to the blower 37, the blower 237 has a split housing 249, wherein the housing has at least one stationary internal wall section 250 which partially divides the housing into two adjacent channels 252 and 253 which extend through and out one side of the housing 249. The air channels 252 and 253 have a substantially equal cross section along their length. The blower includes a pair of impellers 247 and 248 within the housing 249 mounted to a central disk 256 which is secured to and rotates with the input shaft 243. Mounting the first and second impellers on a common shaft ensures that the impellers are driven at the same speed, thereby creating two discharges 255 of air which are at substantially equal in mass flow, pressure, and speed. It is foreseen that the impellers 247 and 248 may be separately mounted on the blower input shaft 243 with the central disk 256 fixedly secured to the radial housing 249 so that the impellers 247 and 248 rotate relative to the stationary central disk 256.

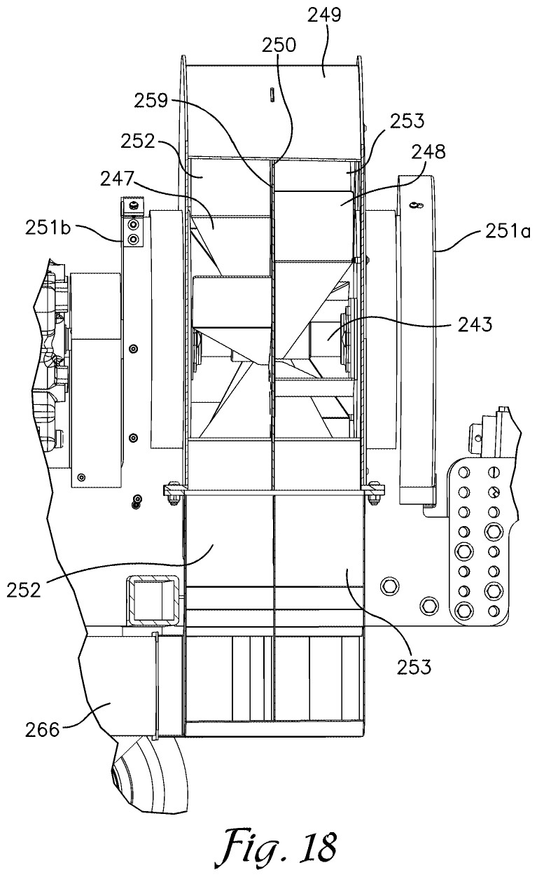

The radial housing is connected to the discharge conduit assembly 231 at a discharge opening 255 of the blower housing 249. In the illustrated embodiment, an inlet section 257 of the discharge conduit assembly 231 is formed as the first and second channels 252 and 253 separated by a divider 259 within a common housing 260 mounted below the blower assembly 221. The channels 252 and 253 of the inlet section 257 initially extend downward and in-line with the discharge opening 255, then curve laterally and horizontally under the blower assembly 221 and then curve rearward and horizontally to extend below the engine 239. First and second discharge conduits or branches 261 and 262 are flow connected to and extend rearward from the first and second channels 252 and 253. Pressurized air is directed from the blower assembly 221 to the first and second discharge conduits (which may be referred to as left and right discharge conduits 261 and 262, respectively) through the internal channel 252 and 253 flow connected thereto. As seen in FIG. 18, the first impeller 247 blows or advances pressurized air through the first channel 252, and through the left discharge conduit 261 (and subsequently the first or left nozzle 229). Likewise, the second impeller 248 blows or advances pressurized air through the second channel 253 into the right conduit 262 and subsequently the right nozzle 230. The use of two impellers 247 and 248 to direct pressurized air through similarly configured discharge conduits 261 and 262 of similar cross-section ensures that each nozzle 229 and 230 receives air at a substantially similar pressure and mass flow rate, meaning that each nozzle's discharge is substantially equally effective in dispersing debris from the ground below.

The left and right discharge conduits 261 and 262 connect to the blower 237 at a proximal end and connect to nozzles 229 and 230, respectively, at a distal end. In the illustrated embodiment, each conduit is held in place by blower frame 223 via the discharge conduit bracket 228 at a point along its length. The conduit bracket 228 contains a pair of through holes sized to allow each discharge conduit 261, 262 to pass through the bracket, while maintaining the conduits 261 and 262 in substantially parallel alignment.

The discharge conduits 261, 262 have two distinct sections of each conduit: a rigid or static portion 261a, 262a, between the blower 237 and a joint or flange 270, and a rotatable or dynamic portion 261b, 262b, between the joint or flange 270 and the nozzle 229, 230.

In the illustrated embodiment, each static section 261a, 262a includes a pair of 45-degree elbows 263 and a straight connector 264 between the two elbows, although it is foreseen that the static section may be formed from any number of suitable conduit or tube connections known to those of skill in the art. The first 45-degree elbow 263 is rigidly connected to the blower discharge opening 259, while the second 45-degree elbow is rigidly connected to the mounting bracket 228.

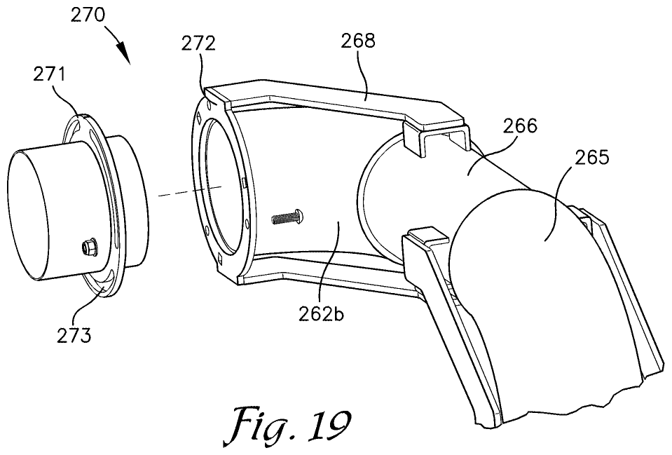

As seen in FIG. 19, each dynamic or rotatable section 261b, 262b in the illustrated embodiment is pivotally or rotatably connected to the static section 261a, 262a at joints 270. Joints 270 include a first and second abutting flange plates 271 and 272, which are of substantially equal diameter. First flange plate 271 includes a plurality of arcuate or semicircular slots 273 extending around a perimeter of the plate, each slot sized to receive a pin or bolt 274 therethrough. The second flange plate 272 includes a plurality of holes configured to receive the bolts 274 around a perimeter of the plate. A nut 275 or other suitable mechanical fastener may be used to join the first plate 271 to the second plate 272, forming the joint 270. The slots 273 allow for the rotatable sections 261b, 262b of the conduits to rotate between approximately zero and 90 degrees about a horizontal axis, relative the static sections 261a, 261b and the blower assembly 221. This allows the conduits and the nozzles 229, 230 to be rotated between an upright or storage configuration and a horizontal or operational configuration (i.e., a portion of the conduits and nozzles are rotatable between zero and 90 degrees relative to vertical).

In the Illustrated embodiment, the first or slotted flange plate 271 is formed around and projects radially outward from the static sections 261a and 261b, while the second flange plate 272 is formed around and projects radially outward from the dynamic sections 262a and 262b to which the nozzles 229 and 230 are connected, although in other embodiments not shown, the orientation of the plates 271 and 272 may be reversed. Additionally, the nuts 275 may be tightened to secure or lock the conduit into an upright position, for storage and during prolonged periods between operations. In other embodiments, there may be an additional locking mechanism (not shown) that achieves a similar function by locking the conduits into an upright, horizontal, or other preferred orientation.

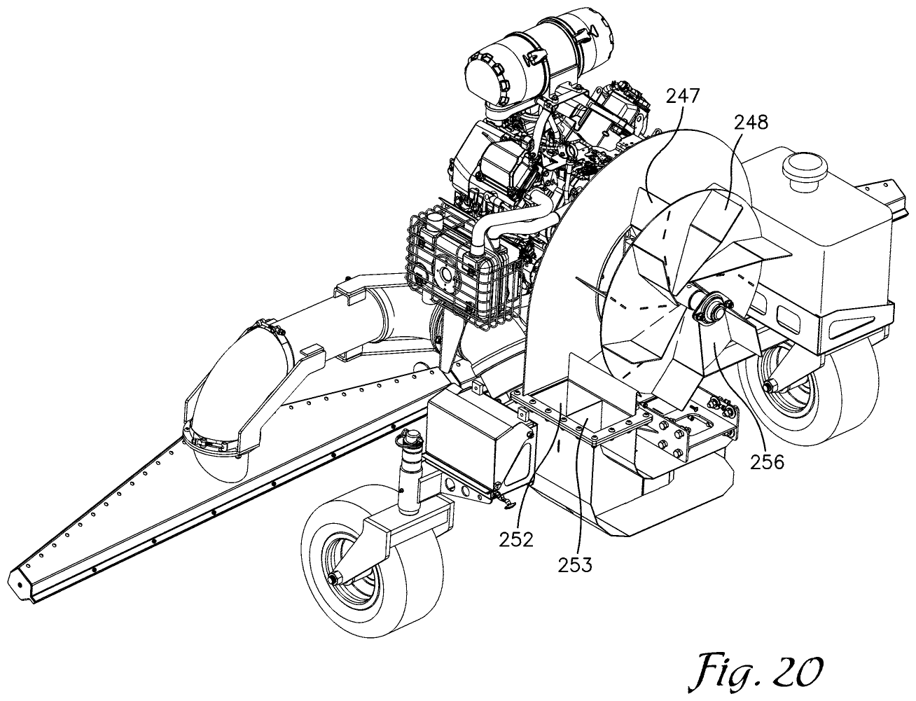

In the embodiment shown in FIGS. 10-20, the dynamic portions 261b and 262b of the conduits may be manually raised or lowered by the user before or after operation. It is foreseen that further embodiments not shown may utilize electric motors, actuators, or other automated methods to move the dynamic portions 261b and 262b conduits between an upright and horizontal configuration. Consequently, these embodiments may include additional electronic control panels, mechanical switches, or other user input devices which the user may interact with to control the position of the conduits 261b and 262b and nozzles 229 and 230.

The dynamic portions 261b, 262b of the conduits in the illustrated embodiment include a pair of 90-degree elbows 265 and a straight connector 266 which adjoins the two elbows. The elbows 265 (as well as elbows 263 in the static portions) may be formed from a rigid or flexible tube material and jointed to the straight connector(s) via a ring clamp 301 or similar devices known to those of skill in the art. The dynamic portions may include additional angular support brackets 268, which are connected at one end to the flange plate 272 and connected at a second end to an exterior surface of the straight connector. The distal ends of the conduits attach to the respective elongate nozzles 229 and 230 at joints 290.

In the embodiment shown, the joints 290 are constructed substantially similar to joints 270 and include first and second flange plates 291 and 292, respectively, wherein the first plate 291 includes a plurality of arcuate slots 293 sized to receive bolts 294 therethrough, and the second plate 292 includes a plurality of holes sized to receive bolts 294 therethrough. The bolts 294 and 274 may be similarly sized and are preferably identical and/or interchangeably used. A nut 295 (similar, and preferably identical to nut 275) or other suitable mechanical fastener may be used to join the first plate 291 to the second plate 292, forming the joint 290.

As with the joint 270, the joint 290 allows for rotation of the nozzles 229 and 230 relative to their respective conduits. Specifically, when in a horizontal or operational configuration, the nozzles 229 and 230 may rotate about a vertical axis. By allowing the nozzles to rotate within a horizontal plane (when in the operational configuration), the nozzles are able to pivot around any ground-level obstructions or similar obstacles that could otherwise inhibit forward movement of the towing vehicle and/or cause damage to the assembly.

Although in the illustrated embodiments, the joint configuration allows for between zero and approximately 90 degrees of rotation, it is foreseen that in other embodiments it may be desirable to restrict the range of rotation further, to less than 45 degrees or fewer. Likewise, it may be advantageous for the joint to include a biasing member such as a torsional spring or the like which may bias the nozzles towards a desired orientation (i.e., perpendicular to the direction of travel).

In the illustrated embodiment, the nozzles 229 and 230 connect to the respective conduits 261 and 262 approximately halfway along the length of the nozzle at an upper surface. By connecting the nozzles to the discharge conduits at a central location along the nozzle, the pressure distribution along the nozzle's length will be symmetrical. Additionally, because the nozzle is connected to the discharge conduit at a central location, nozzles 229 and 230 may be identical in shape, rather than left- or right-side specific nozzles. This reduces complexity of the design and allows for easier maintenance if needed.

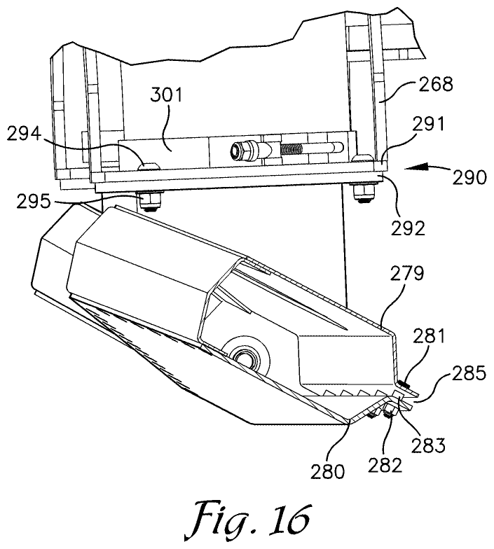

Similar to elongate nozzle 29, the nozzles 229 and 230 may be formed from upper and lower or first and second lengths of semi-hexagonal channels 279 and 280 secured together to form a hexagonal tube. In the embodiment shown in FIGS. 10-20, and as best seen in FIG. 16, the semi-hexagonal channels 279 and 280 may be tapered along their length, such that the hexagonal tube formed resembles a delta-wing shape. The channels 279 and 280 are secured together in spaced apart relationship by fastener assemblies, such as screws 281 and nuts 282. A spacer or washer 283 may be placed around each screw between front edges of the channels to form an air discharge outlet or slot 285 extending the length of the nozzle 229 or 230. The discharge outlet 285 is preferably disposed on a front side of the nozzle, and is angled downwards with respect to the horizontal, as seen in FIG. 16.

Pressurized air is discharged from the blower 237 through the discharge opening 255, the blower channels 252 and 253, into the discharge conduits 261, 262, into an interior space of the nozzles 229 and 230 and out through the discharge slot 285 formed in each nozzle. The discharge slot 285 is preferably angled downward at approximately 45 degrees from the horizontal, to direct the stream of air toward the ground at an angle of 45 degrees. It is foreseen in other embodiments not shown that the angle of the discharge slot 245 may range from approximately 30 degrees to 90 degrees. The discharge slot 285 may be oriented to direct air discharged therefrom forward or rearward relative to the direction of travel of the mower 12.

The nozzles 229 and 230 may, in some embodiments, include a mounting point for an additional roller support 287 on an end face of the nozzle. This additional rolling support provides additional stability to the nozzles while the assembly is traveling over uneven terrain and may allow for additional ground clearance if desired.

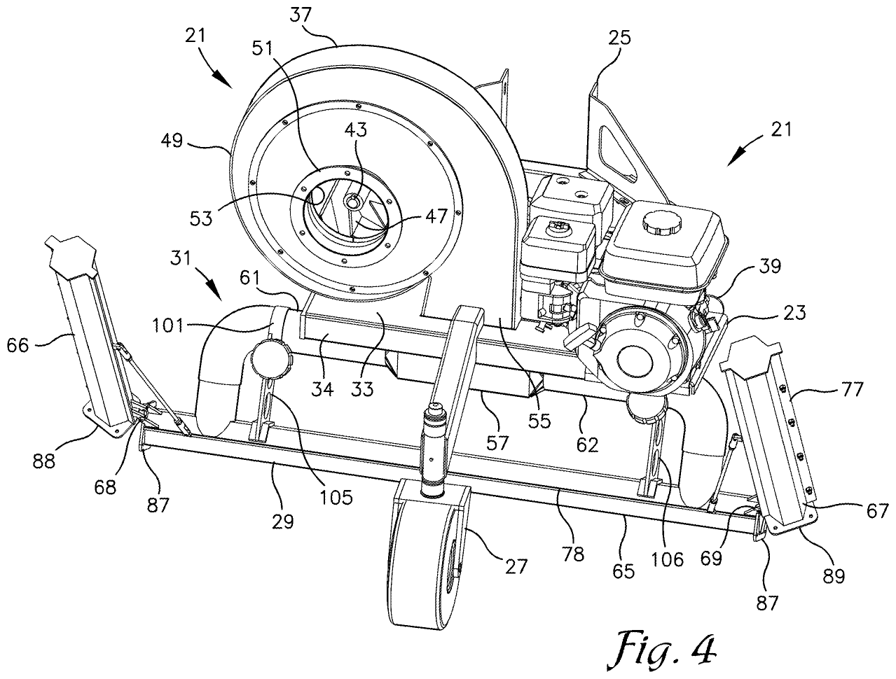

It is foreseen that nozzles 229 and 230 may be formed as a single or segmented nozzle as in the embodiment shown in FIGS. 1-9. Discharge conduits 261a and 261b may then be connected in spaced apart relation to a single nozzle or a central section of the segmented nozzle as generally shown in FIG. 4 for the left and right branches connected to the center section 65 of nozzle 29. Nozzles 229 and 230 connected to a single nozzle or segmented nozzle will also function to direct pressurized air at a relatively uniform pressure across both sides of the nozzle and to the ends thereof.

It is to be understood that while certain forms of the present invention have been illustrated and described herein, it is not to be limited to the specific forms or arrangement of parts described and shown.

1. A debris dispersal system for use with a riding mower, the debris dispersal system comprising:
a blower assembly supported on a platform;
the blower assembly including a blower and an engine drivingly connecting the engine to the blower;
a mower mounting bracket securable to a frame member of the riding mower, the platform pivotally connected to the mower mounting bracket;
an elongated nozzle suspended below the platform and extending laterally relative to the platform, the elongated nozzle having at least one discharge opening oriented for directing air downward from the nozzle the nozzle connected to a discharge opening of the blower by a discharge conduit; and
a rolling support connected to the platform on a side of the platform opposite the pivotal connection of the platform to the mower mounting bracket.

2. The debris dispersal system as in claim 1 further comprising height adjustment means for adjusting the height of the platform relative to the mower mounting bracket.

3. The debris dispersal system as in claim 1 wherein the elongated nozzle is formed form a center section, a left section and a right section, wherein the left section and the right section are pivotally connected to the center section such that the left section and the right section may be pivoted vertically relative to the center section.

4. The debris dispersal system as in claim 1 wherein the nozzle is formed from upper and lower channels connected together to form an interior space therebetween and the at least one discharge opening in the nozzle comprises an elongated air discharge slot formed between the upper and lower channels in communication with the interior space.

5. The debris dispersal system as in claim 1, wherein the blower assembly further comprises a transmission connected between an engine output shaft and a blower shaft, the transmission having a centrifugal clutch connected to the engine output shaft, and wherein the transmission does not drivingly engage the blower shaft until the engine output shaft reaches a set revolutions per minute.

6. The debris dispersal system as in claim 3 wherein the discharge conduit includes a plenum connected to the discharge opening of the blower and left and right conduit branches connected between the plenum and the center section of the nozzle, the left branch including a left horizontal section connected to and projecting from a left side of the plenum, a left elbow connected to the left horizontal section and a left vertical segment connected between the nozzle and the left elbow, the right branch including a right horizontal section connected to and projecting from a right side of the plenum, a right elbow connected to the right horizontal section and a right vertical segment connected between the nozzle and the right elbow.

7. The debris dispersal system as in claim 6 wherein the left and right elbows are rotatably connected to the left and right horizontal segments of the discharge conduit such that the nozzle is rotatable relative to the left and right horizontal segments.

8. The debris dispersal system as in claim 7 further comprising left and right clamping rings surrounding a portion of the left and right elbows extending over the left and right horizontal segments respectively and operable to selectively clamp the left and right elbows to the left and right horizontal segments respectively.

9. The debris dispersal system as in claim 8 further comprising left and right hangers extending between the left and right clamping rings and the nozzle for suspending the nozzle from the left and right horizontal segments.

10. The debris dispersal system as in claim 1 wherein the platform is pivotally connected to the mower mounting bracket to pivot about a substantially horizontal axis.

11. A debris dispersal system for use with a vehicle, the system comprising:
a blower assembly supported on a platform, the blower assembly including a blower and an engine drivingly connected to the blower;
a mower mounting bracket securable to a frame of the vehicle and pivotally connected to the platform;
first and second discharge conduits, each conduit having a proximal end connected to a discharge opening of the blower and a distal end connected to an elongate nozzle, each nozzle having at least one discharge opening configured to direct air downward from the nozzle; and
first and second rolling supports connected to the platform, the first and second rolling supports being disposed on opposite sides of the platform.

12. The debris dispersal system as in claim 11, wherein the blower comprises:
a radial housing having first and second adjacent radial channels of substantially equal cross-sectional area, a first set of impeller blades disposed within the first radial channel, and a second set of impeller blades disposed within the second radial channel, wherein the first set of impeller blades and second set of impeller blades are mounted upon a common shaft.

13. The debris dispersal system as in claim 11, wherein a portion of the first and second discharge conduits are rotatable about a substantially horizontal axis between zero and 90 degrees relative to vertical.

14. The debris dispersal system as in claim 11, wherein the first and second elongated nozzles are rotatable about a substantially vertical axis when in an operational configuration, relative to the distal end of the first and second discharge conduits, respectively.

15. The debris dispersal system as in claim 15, wherein the first and second elongated nozzles are rotatable independently from each other.

16. The debris dispersal system as in claim 11, wherein each nozzle further comprises at least one rolling support connected to an end portion of the nozzle.

17. The debris dispersal system as in claim 11, wherein the distal end of the first and second discharge conduits is connected to the first and second elongated nozzles approximately halfway along the length of the respective nozzles.

18. The debris dispersal system according to claim 11, wherein a portion of the first and second discharge conduits is formed from a nonrigid material.

19. The debris dispersal system as in claim 13, further comprising a locking mechanism configured to selectively secure a portion of the first and second discharge conduits in an upright configuration.

20. The debris dispersal system as in claim 12, wherein the first radial channel is connected to the first discharge conduit at a first discharge opening, the second radial channel is connected to the second discharge conduit at a second discharge opening, and the first and second discharge openings are horizontally oriented.

21. A debris dispersal system for use with a vehicle, comprising:
a blower assembly supported on a frame, the blower assembly including an engine drivingly connected to a blower, the blower having a radial housing with first and second internal radial channels of substantially equal cross-sectional area, a first set of impeller blades disposed within the first radial channel, and a second set of impeller blades disposed within the second radial channel, wherein the first set of impeller blades and second set of impeller blades are mounted to rotate about a common axis;
a nozzle assembly including at least one nozzle, each nozzle having at least one discharge opening configured to direct air downward from the nozzle;
first and second discharge conduits, each having a proximal end connected to the blower and a distal end connected to the nozzle assembly in spaced relation.

22. The debris dispersal system as in claim 21, further comprising a mower mounting assembly securable to the vehicle and pivotally connected to the frame.

23. The debris dispersal system as in claim 21, wherein a portion of the first and second discharge conduits are rotatable about a substantially horizontal axis between zero and 90 degrees.

24. The debris dispersal system as in claim 21, wherein the nozzle assembly comprises first and second elongated nozzles, each nozzle being rotatable relative to the distal end of the first and second discharge conduits, respectively.

25. The debris dispersal system as in claim 21, wherein a first portion of the nozzle is substantially horizontal, and a second portion of the nozzle is rotatable relative to the first portion.
